(19) United States
(12) Patent Application Publication
(10) Pub. No.: US 2014/0057134 A1
(43) Pub. Date: Feb. 27, 2014

(54) MAGNETIC RECORDING MEDIUM FOR THERMALLY ASSISTED RECORDING

(71) Applicant: FUJI ELECTRIC CO., LTD., Kawasaki-shi (JP)

(72) Inventor: Yuki INABA, Matsumoto-city (JP)

(21) Appl. No.: 13/917,167

(22) Filed: Jun. 13, 2013

(30) Foreign Application Priority Data
Aug. 22, 2012 (JP) 2012-183149

(51) Int. Cl. G11B 13/04

(52) U.S. Cl. CPC G11B 13/04
USPC 428/834; 427/553

(57) ABSTRACT

A magnetic recording medium is capable of improving the efficiency of thermal energy supply to a magnetic recording layer. A magnetic recording medium for thermally assisted recording comprises at least a nonmagnetic substrate, a magnetic recording layer, and a reflectance change layer. The magnetic recording layer is positioned between the substrate and the reflectance change layer.

### BACKGROUND OF THE INVENTION

1. Field of the Invention

This invention relates to a magnetic recording medium mounted in various kinds of magnetic recording devices, and more specifically, this invention relates to a magnetic recording medium for thermally assisted recording.

2. Description of the Related Art

Hard disk devices, magneto-optical (MO) recording devices, magnetic tape devices, and other magnetic recording devices have long been used as external recording devices for computers. Two methods, in-plane magnetic recording and perpendicular magnetic recording, have been used as the methods of magnetic recording on the hard disks, MO media and magnetic tapes used in these magnetic recording devices. In both magnetic recording methods, resolving the problem of thermal fluctuations accompanying microminiaturization of recording magnetization has been important to secure long-term stability of recorded signals.

In order to resolve the problem of thermal fluctuations, energetic research is being conducted on formation of magnetic recording layers using materials having high magnetic anisotropy energy. The magnetic anisotropy energy is the amount of energy used for holding a recorded magnetization (signal) in one direction. However, material having high magnetic anisotropy energy requires high magnetic field intensities for signal writing and erasure. Hence in current magnetic recording systems, the upper limit to the magnetic anisotropy energy of materials which can be used to form magnetic recording layers is defined by the magnetic field intensity which can be generated by the signal read/write head.

In recent years much effort has been devoted to development of energy assisted recording methods, in which energy is supplied to the magnetic recording layer from outside at the time of signal read/write to temporarily reduce the magnetic anisotropy energy of the magnetic recording layer and reduce the magnetic field intensity necessary for signal read/write, as means of avoiding the above-described constraint and attaining high-density magnetic recording.

Among energy assisted magnetic recording methods, thermally assisted magnetic recording methods, in which thermal energy is supplied to the magnetic recording layer, are currently being studied the most vigorously. In particular, use of light irradiation is being studied as means of supplying thermal energy. In a thermally assisted magnetic recording method using light irradiation, the magnetic recording layer is heated by light irradiation with laser light or similar at the time of signal read/write, intentionally creating a thermally unstable state (that is, a state with low magnetic anisotropy energy), to increase the read/write capability. On the other hand, after the end of signal read/write, the magnetic recording layer is cooled and again changed to a thermally stable state (that is, a state with high magnetic anisotropy energy), and thermal stability of the signal (magnetization) is secured.

In work on thermally assisted magnetic recording methods, magnetic recording materials with a large temperature dependence of the magnetic anisotropy energy (that is, the rate of decrease of the magnetic anisotropy energy with rising temperature) are being developed. On the other hand, little research is in progress to improve the efficiency of provision of thermal energy to magnetic recording layers. In particular, there have been no reports on the configuration of magnetic recording media for the efficient supply of thermal energy to a desired position.

In thermally assisted magnetic recording methods, thermal energy is supplied to a magnetic recording layer in a region in which recording is performed, causing the temperature of the magnetic recording layer to rise. By raising the temperature of the magnetic recording layer to the vicinity of the Curie point, the magnetic anisotropy energy is reduced, and recording by a magnetic head is made easy. On the other hand, in adjacent regions it is preferable that the temperature of the magnetic recording layer be as low as possible, in order that recording not be performed. In other words, it is necessary to supply thermal energy so as to induce a large temperature gradient between the position at which recording is desired and positions at which recording is not desired.

Metal alloys constitute the mainstream of materials used in magnetic recording layers; such metals have a metallic luster. Consequently reflectance is extremely high, and when using laser light, a method for efficiently heating the medium has been deemed necessary.

### SUMMARY OF THE INVENTION

A magnetic recording medium of this invention includes at least a nonmagnetic substrate, a magnetic recording layer, and a reflectance change layer, and is characterized in that the magnetic recording layer is positioned between the substrate and the reflectance change layer. A magnetic recording medium of this invention is preferred for thermally assisted recording. Further, it is preferable that the reflectance change layer be formed from a material the reflectance of which can be changed reversibly. Here, the reflectance change layer may be formed from a material the reflectance of which can be changed by irradiation with control light material, or using a phase transition material. For example, the reflectance change layer may be formed from a material including one or a plurality of elements selected from a group consisting of germanium (Ge), antimony (Sb), tellurium (Te), gallium (Ga) and selenium (Se), or may be formed from a metal-semiconductor phase transition material made of Ti₃O₅. Further, it is preferable that the reflectance change layer have a low-reflectance region and a high-reflectance region, and that the reflectance of the low-reflectance region be equal to or lower than the reflectance of the high-reflectance region. Here, the low-reflectance region can be formed in a portion of a recording track or in a portion of a servo region of the magnetic recording medium.

By adopting a configuration described above, a magnetic recording medium of this invention can be provided having a structure which can improve the efficiency of heating of the magnetic recording layer in energy assisted recording methods, and in particular in thermally assisted recording methods using laser light.

Further, in a magnetic recording medium of this invention, by providing a low-reflectance region and a high-reflectance region in the reflectance change layer, high-intensity laser light can be supplied to the magnetic recording layer below the low-reflectance region, so that consequently the efficiency of heating of the magnetic recording layer can be enhanced. Further, the difference in amounts of laser light supply to the magnetic recording layer in the low-reflectance region and in the high-reflectance region can be used to enhance the efficiency of heating of the magnetic recording layer only in a specific region (a recording track, servo pattern recording region, or the like) below the low-reflectance region, and to impart a large temperature gradient in an in-plane direction of the magnetic recording layer.

### BRIEF DESCRIPTION OF THE DRAWINGS

FIG. 1 is a cross-sectional view showing an example of the configuration of a magnetic recording medium of the invention; and

FIGS. 2A to 2C explain the principle of reducing the track width by changing the reflectance, in which FIG. 2A shows a case in which the entire face is a low-reflectance region, FIG. 2B shows a case in which the entire face is a high-reflectance region, and FIG. 2C shows a case in which there is a low-reflectance region, corresponding to tracks, and a high-reflectance region, on the periphery of tracks.

### DETAILED DESCRIPTION

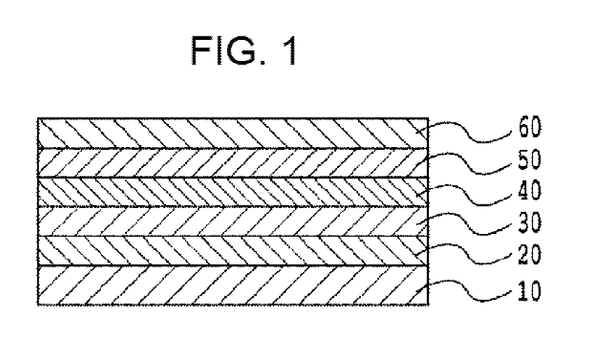

A magnetic recording medium of this invention includes at least a nonmagnetic substrate, a magnetic recording layer, and a reflectance change layer, and is characterized in that the magnetic recording layer is positioned between the substrate and the reflectance change layer. Further, a magnetic recording medium of this invention may further include, between the substrate and the magnetic recording layer, a heat sink layer, a soft magnetic underlayer, a seed layer, an underlayer, or other layers. Further, on the magnetic recording layer in this invention, a protective layer, a liquid lubricating layer, or other layers may be further included. In addition, in this invention the reflectance change layer may have the function of a protective layer. Or, a magnetic recording medium of this invention may have a protective layer formed separately from the reflectance change layer. FIG. 1 shows an example of the configuration of a magnetic recording medium of this invention, including a nonmagnetic substrate 10, a seed layer 20, an underlayer 30, a magnetic recording layer 40, a reflectance change layer 50, and a liquid lubricating layer 60.

As the nonmagnetic substrate 10 in this invention, a glass substrate, an Al substrate, a surface-oxidized Si wafer, a quartz substrate, a resin substrate, or the like can be used. Here, when applied to a thermally assisted recording method, the nonmagnetic substrate 10 is also affected by heating during heating of the magnetic recording layer 40. Hence the material for the nonmagnetic substrate 10 must be selected considering the melting point, the softening point, the glass transition point, and other characteristics.

The magnetic recording layer 40 in this invention can be formed from any material used in the art. The magnetic recording layer 40 can be formed from a Co alloy, and preferably a CoPt-base alloy including Co and Pt. A CoPt-base alloy may further include a metal such as Cr, B, Ta or W. The magnetic material forming the magnetic recording layer 40 may have a granular structure in which magnetic crystal grains of the above-described CoPt-base alloy are separated by nonmagnetic grain boundaries comprising an oxide (SiO₂, TiO₂ or similar) or a nitride of Si, Cr, Co, Ti or Ta.

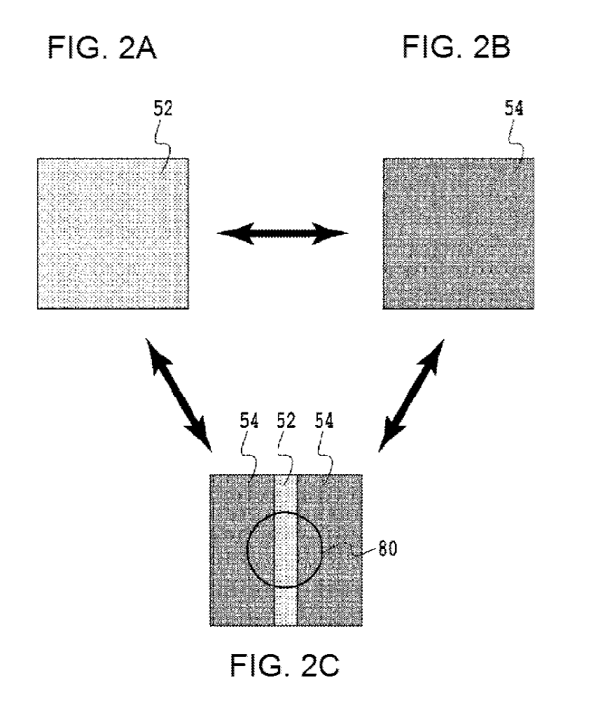

The reflectance change layer 50 in this invention controls the reflectance, and is a layer to change the intensity of irradiated light reaching the magnetic recording layer 40 at the time of signal read/write. By changing the intensity of irradiated light, the efficiency of heating of the magnetic recording layer 40 can be controlled. As shown in FIGS. 2A to 2C, it is preferable that the change in reflectance of the reflectance change layer 50 be reversible. In other words, it is preferable that it be possible to change from the state shown in FIG. 2A in which the entire region of the reflectance change layer 50 is a low-reflectance region 52 to the state shown in FIG. 2B in which the entire region of the reflectance change layer 50 is made a high-reflectance region 54 by an external stimulus, and that be possible to change from the state of FIG. 2B to the state shown in FIG. 2A by an external stimulus. Further, it is preferable that, through positionally selective external stimulus, a low-reflectance region 52 or high-reflectance region 54 can be changed from the state of FIG. 2A or FIG. 2B to the state shown in FIG. 2C, formed by positional selection. Further, it is preferable that by external stimulus over the entire face, the state of FIG. 2C can be changed to the state of FIG. 2A or FIG. 2B. In this invention, “low-reflectance region 52” means a region with low reflectance with respect to light irradiated at the time of signal read/write. And, “high-reflectance region 54” means a region with high reflectance with respect to light irradiated at the time of signal read/write.

Further, it is preferable that the reflectance change layer 50 in this invention have a high transmittance for light used in thermally assisted recording (hereafter called “recording light”), so that more of the recording light reaches the magnetic recording layer 40. Further, it is preferable that, when changes in the low-reflectance region 52 and high-reflectance region 54 are made using light (hereafter called “control light”), the reflectance change layer 50 have a high absorptivity for control light, and causes the above change at small light quantities. The wavelengths of light used as recording light and as control light are selected appropriately according to the material of the reflectance change layer 50. When reflectance changes occur due to an element other than a light wavelength, the recording light and the control light may have the same wavelength, or may have different wavelengths. One such example is a case in which changes in reflectance occur due to temperature changes or similar brought about by light irradiation. When changes between a low-reflectance region 52 and a high-reflectance region 54 of the reflectance change layer 50 occur due to light in different wavelength ranges, light in different wavelength ranges is used for the recording light and for the control light. By making the recording light peak wavelength and the control light peak wavelength coincide with the peak wavelength inducing changes between a low-reflectance region 52 and a high-reflectance region 54, a desired reflectance change can be induced using smaller amounts of light. Further, when the wavelength causing changes in reflectance is limited, as in the case of Ti₃O₅ in an example described in S. Ohkoshi et al, Nature Chemistry, Vol. 2, 539-545 (2010), which changes to brown when the irradiating light wavelength is 532 nm and changes to black when the wavelength is 410 nm, the recording light wavelength must be set appropriately such that the desired change is made to the reflectance of the reflectance change layer.

In the state of FIG. 2C, in which a low-reflectance region 52 and a high-reflectance region 54 are positionally selected and formed, the reflectance change layer 50 can select the region heated within the magnetic recording layer 40. That is, in FIG. 2C, when the range indicated by the reference symbol 80 (a laser spot) is irradiated with laser light, only the magnetic recording layer 40 below the low-reflectance region 52 included in the laser spot 80 is heated, and the magnetic recording layer 40 below the high-reflectance region 54 in the laser spot 80 is not heated. As a result, at a boundary between the low-reflectance region 52 and the high-reflectance region 54, the temperature gradient in an in-plane direction in the magnetic recording layer 40 therebelow can be made sharp, raising the recording density. In other words, the magnetic recording layer 40 can be heated in a smaller region, without decreasing the diameter of the laser spot 80 (the laser spot diameter). Because the size of the recording region in the magnetic recording layer 40 is controlled not by the laser spot diameter but by the size of the low-reflectance region 52, a high-output laser with a large laser spot diameter can be used. Further, the need to reduce the laser spot diameter is relaxed, so that more freedom is afforded in designing the laser and the laser optical system.

Further, by forming a low-reflectance region 52 in positions corresponding to a plurality of recording tracks with concentric circle shapes, a discrete track medium (DTM), in which the plurality of recording tracks are magnetically independent, is obtained. In a magnetic recording medium of this invention, this method is effective for enabling realization of DTM without using a lithography process. Further, by forming low-reflectance regions 52 corresponding to each of the recording bits in a magnetic recording medium, a patterned medium, in which each recording bit is magnetically independent, can be obtained.

Further, using a low-reflectance region 52 and a high-reflectance region 54 which are positionally selected and formed, a servo pattern can be formed in which the recording track position information in the magnetic recording medium, the sector position information in a recording track, and other information is embedded. For example, a low-reflectance region 52 is formed in a pattern corresponding to servo information in a position at which servo information is to be recorded, and a high-reflectance region 54 is formed in a remainder. Then, by performing writing under conditions similar to those for ordinary recording tracks, servo information corresponding to the servo pattern can be written to the magnetic recording layer 40. Here, simultaneously with formation of the servo pattern, a recording track or recording bit pattern may be formed as well. A pattern of recording tracks or recording bits is obtained by forming low-reflectance regions 52 in positions corresponding to the recording tracks or recording bits, and forming high-reflectance regions 54 in the remainder.

Further, by using a reflectance change layer 50 in which reflectance changes occur reversibly, the recording region of the magnetic recording layer 40 can be changed as necessary. As one embodiment in which control light is used to change the recording region as necessary, below an example is explained of a method of performing successive recording on adjacent recording tracks. Suppose A, B and C are three adjacent recording tracks. This method includes:

a process of using control light to convert the reflectance change layer 50 in the regions of the recording tracks A, B and C into a high-reflectance region 54;

a process of using control light to convert the reflectance change layer 50 in the region of the recording track B into a low-reflectance region 52;

a process of using a magnetic head for thermally assisted magnetic recording to record desired data onto the recording track B;

a process of using control light to convert the reflectance change layer 50 in the region of the recording track B into a high-reflectance region 54;

a process of using control light to convert the reflectance change layer 50 in the region of the recording track C into a low-reflectance region 52; and a process of using the magnetic recording head to record desired data onto the recording track C.

By means of the above method, the effect on adjacent recording tracks attributed to both the optical energy of recording light used in thermally assisted magnetic recording and the leakage magnetic field of the magnetic head can be held to a minimum. As a result, the distance between recording tracks can be set to the minimum value, and recording can be performed at high densities. If the method of changing the recording region as necessary is applied to a shingled magnetic recording method in which recording tracks are recorded with overlapping, still higher recording track densities can be made possible.

Materials which can be used to form a reflectance change layer 50 of this invention include materials the reflectance of which can be changed reversibly by means of a phase transition between a crystalline state and an amorphous state as a result of a change in heating/cooling conditions. Much vigorous development of phase transition memories using phase transition materials is being conducted. In DVD-RAM and other optical recording media, phase transition materials including the three elements germanium (Ge), antimony (Sb) and tellurium (Te) are being used. Among such phase transition materials, GeSb₂Te₄, Ge₂Sb₂Te₅, and similar materials are known (see N. Yamada et al, J. Appl. Phys., Vol. 69, 2849-2856 (1991) and A. V. Kolobov et al, Nature Mater., Vol. 3, 703-708 (2004)). In addition, in recent years Sb—X alloys (where X includes Ge, gallium (Ga), selenium (Se), Te, and the like), having antimony as the main component and with a composition in the vicinity of the eutectic composition, have been studied. These materials enter into an amorphous state upon being heated to the melting point Tm (liquidus temperature) or higher and then cooling (rapid cooling), and enter into a crystalline state upon heating to a temperature at the crystallization temperature Tc or higher and at or below Tm and then cooling (slow cooling).

Further, materials which can be used to form a reflectance change layer 50 of this invention include materials the reflectance of which is changed by a change in electronic state based on a temperature change or light irradiation. Examples of such materials include iron (Fe) complexes the electronic state of which changes due to spin crossover (see P. Gutlich et al, Angew. Chem. Int. Ed. Engl., Vol. 33, 2024-2054 (1994), O. Kahn et al, Science, Vol. 279, 44-48 (1998), S. Decurtins et al, Chem. Phys. Lett., Vol. 105, 1-4 (1984), and J. F. Letard et al, J. Am. Chem. Soc., Vol. 121, 10630-10631 (1999)); metal polycyanides (also called cyanide bridging metal complexes, polycyanometallates, and the like; see S. Ohkoshi et al, J. Photochem. Photobiol., Vol. C2, 71-88 (2001), M. Verdaguer, Science, Vol. 272, 698-699 (1996), S. Ohkoshi et al, Appl. Phys. Lett., Vol. 70, 1040-1042 (1997), J. M. Herrera et al, Angew. Chem. Int. Ed., Vol. 43, 5468-5471 (2004), A. Dei, Angew. Chem. Int. Ed., Vol. 44, 1160-1163 (2005), S. Ohkoshi et al, J. Am. Chem. Soc., Vol. 128, 5320-5321 (2006), and H. Tokoro et al, Chem. Mater., Vol. 20, 423-428 (2008)); and perovskite type manganites represented by the chemical formula R₁₋ₓAₓMnO₃ (in which R is a trivalent rare earth metal ion and A is a bivalent alkali earth metal ion) (see K. Miyano et al, Phys. Rev. Lett., Vol. 78, 4257-4260 (1997) and M. Fiebig et al, Science, Vol. 280, 1925-1928 (1998)).

Further, a material which can be used in a reflectance change layer 50 of this invention includes a composite that can perform photoinduced charge movement between an electron donor and an electron acceptor. For example, it is known that a composite of thiafulvalene, which is an electron donor, and chloranil, which is an electron acceptor, changes from a neutral state into an ionic state through optical stimulation, so that the reflectance changes, and a paramagnetic-ferromagnetic phase transition is induced (see S. Koshihara et al, Phys. Rev. B, Vol. 42, 6853-6856 (1990), and E. Collet et al, Science, Vol. 300, 612-615 (2003)).

Further, materials which can be used to form a reflectance change layer 50 in this invention include materials which cause changes in reflectance through changes in crystal structure. For example, titanium oxide (Ti₃O₅) is known to undergo a photoreversible metal-semiconductor phase transition at room temperature (see S. Ohkoshi et al, Nature Chemistry, Vol. 2, 539-545 (2010)). This material undergoes reversible changes between a low-reflectance λ phase and a high-reflectance β phase as a result of irradiation with laser light at different wavelengths. Further, it is known that in a Langmuir-Blodgett film of 4-nitro-4′-N-octadecylazobenzene, an azimuth angle anisotropy in second harmonic generation is changed by light irradiation (see O. A. Aktsipetrov et al, Jpn. J. Appl. Phys., Vol. 37, 122-127 (1998)). And, it is known that a compound in which 1,2-bis(2-methoxy-4-phenyl-3-thienyl)perfluoro cyclopentane and 1,5-dimethoxy-9,10-bis(phenyl-ethynyl)anthracene are bonded with an adamantyl spacer therebetween undergoes reversible changes between a fluorescent ring-opening state and a non-fluorescent ring-closure state as a result of light irradiation (see M. Irie et al, Nature, Vol. 420, 759-760 (2002)). Further, it is known that Dronpa, a variant green fluorescent protein (GFP), undergoes reversible changes between a light state and a dark state due to irradiation with light at 488 nm and 405 nm (see S. Habuchi et al, Proc. Natl. Acad. Sci. USA, Vol. 102, 9511-9516 (2005)).

Further, it has been disclosed that by heat treatment of a film formed from an organic polymer including 70% or more aromatic polyamides, the surface roughness is changed (see Japanese Patent Application Publication No. 2000-344915). This change is not reversible, but by changing the film surface roughness, the film reflectance can be changed. In cases where reversibility is not required, clearly the above-described organic polymer can be applied to formation of a reflectance change layer 50 of this invention. This organic polymer is characterized in that an extremely wide variety of materials can be used as the material other than the aromatic polyamide.

Further, in a magnetic recording medium for thermally assisted recording, a heat sink layer (not shown), which absorbs excess heat generated in the magnetic recording layer 40, may be further provided below the magnetic recording layer 40. From the standpoint of strength and the like, the heat sink layer can be formed from an Al—Si alloy, a Cu—B alloy or the like. Further, a Sendust (FeSiAl) alloy, a soft magnetic CoFe alloy, or the like can be used to form a heat sink layer, imparting the function of a soft magnetic underlayer (described below) to the heat sink layer. The optimum value for the film thickness of the heat sink layer varies depending on the amount of heat and heat distribution at the time of thermally assisted magnetic recording, as well as the layer configuration of the magnetic recording medium and the thicknesses of each of the constituent layers. When depositing the film continuously with other constituent layers, from considerations of productivity, it is preferable that the thickness of the heat sink layer be 10 nm or greater and 100 nm or less. A heat sink layer can be formed using a sputtering method (including a DC magnetron sputtering method or the like), a vacuum evaporation deposition method, or any other methods known in the art. In ordinary cases, a sputtering method is used to form a heat sink layer.

Further, in a magnetic recording medium for a perpendicular magnetic recording method, a soft magnetic underlayer (not shown) to concentrate the perpendicular-direction magnetic field generated by the magnetic head for recording in the magnetic recording layer 40 may be provided below the magnetic recording layer 40. Soft magnetic materials used to form a soft magnetic underlayer include alloys of Co, Fe, Ni and other magnetic metals with elements highly capable of forming amorphous structures such as Zr, Ta, Nb, Ti, Mo, W, Si, B and similar. A soft magnetic underlayer can be formed using any technique known in the art. From the standpoints of the quality of the soft magnetic underlayer obtained, the ease of controlling the film thickness, and the high rate of film deposition, it is preferable that a DC magnetron sputtering method be used to form a soft magnetic underlayer. The thickness of the soft magnetic underlayer depends on the magnetic flux density generated by the magnetic head for recording. In general, soft magnetic underlayer has a thickness of approximately 10 nm to 50 nm.

A seed layer 20 has the functions of controlling the crystal orientation of the underlayer 30, and consequently of controlling the crystal orientation of magnetic crystal grains in the magnetic recording layer 40 which is the layer thereabove. The seed layer 20 can be formed from NiW, Ta, Cr, or an alloy including Ta and/or Cr. Or, the seed layer can be formed as a stacked-layer structure comprising a plurality of layers including the above-described materials.

An underlayer 30 is a layer used to control the crystal grain diameters and crystal orientation in the magnetic recording layer 40, and to prevent magnetic coupling between the soft magnetic underlayer (when the latter exists) and the magnetic recording layer 40. Hence it is preferable that the underlayer 30 be nonmagnetic. The crystal structure of the underlayer 30 is selected appropriately to conform to the material of the magnetic recording layer 40. For example, when the magnetic recording layer 40 positioned immediately above is formed from a material the main material of which is Co having a hexagonal close-packed (hcp) structure, the underlayer 30 can be formed from a material having an hcp or a face-centered cubic (fcc) structure. Or, the underlayer 30 can have an amorphous structure. It is preferable that the material used to form the underlayer 30 include Ru, Re, Rh, Pt, Pd, Ir, Ni, Co, or an alloy including these.

A protective layer (not shown) can be formed from a material conventionally used in the art of magnetic recording media (a material the main component of which is carbon, or the like). A protective layer may be a single layer, or may have a stacked-layer structure. A protective layer with a stacked-layer structure may have a stacked-layer structure of two types of carbon-based materials with different characteristics, or a stacked-layer structure of a metal and a carbon-based material, or a stacked-layer structure of a metal oxide film and a carbon-based material. The protective layer may be formed using a sputtering method (including a DC magnetron sputtering method and similar), a vacuum evaporation deposition method, or any other method known in the art. Or, when the reflectance change layer 50 has appropriate mechanical strength, the reflectance change layer 50 can be used as a protective layer.

A liquid lubricating layer 60, which can be arbitrarily adopted and provided as the uppermost layer of a magnetic recording medium, can be formed from a material conventionally used in the art of magnetic recording media (for example, a perfluoro polyether based lubricant, or the like). A liquid lubricating layer 60 can be formed using for example a dip coating method, a spin coating method, or other application method. Or, when the reflectance change layer 50 has appropriate lubricating properties, the reflectance change layer 50 can be used as a lubricating layer.

### EXAMPLES

Advantageous results of the invention are further explained through the examples and comparative example described below. Given the principle of the invention, advantageous results expected in this invention can be exhibited in either in-plane magnetic recording or in perpendicular magnetic recording methods. In the following examples and comparative example, a perpendicular magnetic recording method is used. However, it should be noted that the layer configurations, the compositions, the film thicknesses, and other conditions of the following examples do not limit the advantageous results of the invention.

### Example 1

An ordinary perpendicular magnetic recording medium semi-finished product was prepared, having, on a silicon substrate with a nominal dimension of 2.5 inches, a nonmagnetic underlayer of Ru, and a magnetic recording layer comprising a granular material of a magnetic alloy the main components of which were Co, Pt and Cr, with SiO₂ added. Next, an electron beam coevaporation method was used to deposit GeSbTe on the magnetic recording layer, to form a reflectance change layer of thickness 100 nm. Next, the perpendicular magnetic recording medium semi-finished product was heated for 10 minutes at 200° C., to induce crystallization of the reflectance change layer. Then, a perfluoro polyether based lubricant was applied onto the reflectance change layer to form a liquid lubricating layer, to obtain a perpendicular magnetic recording medium.

### Example 2

Except for not inducing crystallization of the reflectance change layer, the same procedure as in Example 1 was used to obtain a perpendicular magnetic recording medium.

### Example 3

A perpendicular magnetic recording medium was fabricated using the same procedure as in Example 1, and after the liquid lubricating layer was formed, laser light with a spot diameter of 100 nm and wavelength 410 nm was used to irradiate a position corresponding to a recording track, and a perpendicular magnetic recording medium was obtained.

### Example 4

Cetyltrimethylammonium bromide (CTAB), 1-butanol, n-octane and water were mixed to form an emulsion. Here the molar ratio of water to CTAB was 17:1. To the emulsion thus obtained were added an 0.50 mole/dm³ TiCl₄ aqueous solution and an 11 mole/dm³ NH₃ aqueous solution. Finally, 22 millimoles of tetraethoxysilane (Si(OC₂H₅)₄) were added, and a solution was obtained including a precipitate of Ti(OH)₄ nanoparticles covered with SiO₂ (see S. Ohkoshi et al, Nature Chemistry, Vol. 2, 539-545 (2010)). This solution was applied onto the magnetic recording layer of the perpendicular magnetic recording medium semi-finished product used in Example 1, to form a film of thickness 100 nm, cleaning was performed using chloroform and methanol, and heating was performed for 5 hours at 1200° C. in a hydrogen flow to obtain a reflectance change layer 100 nm thick in which Ti₃O₅ particles having diameters of approximately 7 nm were dispersed. The particle diameters of the Ti₃O₅ particles in the reflectance change layer were substantially the same as the diameters of the CoPtCr magnetic crystal grains in the magnetic recording layer. Next, a liquid lubricating layer was formed similarly to Example 1. Then, the entire face of the magnetic recording medium semi-finished product was irradiated with monochromatic light of wavelength 532 nm, to obtain a perpendicular magnetic recording medium.

### Example 5

Except for the fact that the wavelength of the monochromatic light used in the final irradiation was changed to 410 nm, the procedure of Example 4 was repeated, and a perpendicular magnetic recording medium was obtained.

### Example 6

After performing processes up to the monochromatic light irradiation using the same procedure as in Example 4, laser light with a spot diameter of 100 nm and wavelength 410 nm was used to irradiate a position corresponding to a recording track, and a perpendicular magnetic recording medium was obtained.

### Example 7

Except for changing the spot diameter of the laser light used to irradiate a position corresponding to a recording track to 200 nm, the procedure of Example 6 was repeated, and a perpendicular magnetic recording medium was obtained.

### Comparative Example 1

Except for the fact that a reflectance change layer was not formed, the procedure of Example 1 was repeated, and a perpendicular magnetic recording medium was obtained.

Evaluation 1

Table 1 shows the materials of the reflectance change layers in Examples 1 to 7 and Comparative example 1, as well as the reflectances of the recording tracks and the portions other than the recording tracks (on the periphery of the recording tracks). Here the reflectance was measured in the wavelength range 300 nm to 1000 nm using a JASCO spectrometer model V-670. Table 1 shows the reflectances at the wavelength of recording light.

The reflectance change layer comprising GeSbTe of Example 2 had not undergone heat treatment and so had an amorphous structure, and had a low reflectance. On the other hand, in Example 1, crystallization of the GeSbTe occurred due to heat treatment for 10 minutes at 200° C., and the reflectance change layer had a high reflectance. No change in characteristics of the magnetic recording layer due to the above-described heat treatment was observed. In Example 3, in which irradiation of recording tracks with laser light at 410 nm was performed, the reflectance of recording tracks was a smaller value than the reflectance on the recording track periphery.

On the other hand, in Examples 4 and 5, in which the reflectance change layer included Ti₃O₅, the reflectance of the reflectance change layer of Example 4, in which the Ti₃O₅ structure was made a β structure by irradiating with monochromatic light at wavelength 532 nm, was greater than the reflectance of the reflectance change layer of Example 5, in which the Ti₃O₅ structure was made a λ structure by irradiating with monochromatic light at wavelength 410 nm. Further, in Examples 6 and 7, in which recording tracks were irradiated with laser light at 410 nm, the reflectance of recording tracks was a lower value than the reflectances on the recording track peripheries.

In all of the perpendicular magnetic recording media of Examples 1 to 7 and Comparative Example 1, the reflectance of the liquid lubricating layer to laser light (wavelength 410 nm) used when recording is substantially 0, and substantially all of the laser light penetrated the liquid lubricating layers.

TABLE 1
Configuration of reflectance change layers

Reflectance (%)

| | | |
|---|---|---|
| | | Recording |
| Reflectance | Recording | track |
| change layer | track | periphery |

| | | |
|---|---|---|
| Example 1 | GeSbTe | 63 |
| Example 2 | | 35 |

| | | |
|---|---|---|
| Example 3 | 35 | 63 |

| | | |
|---|---|---|
| Example 4 | Ti₃O₅ | 55 |
| Example 5 | | 8 |

| | | |
|---|---|---|
| Example 6 | 8 | 55 |
| Example 7 | 8 | 55 |

| | | |
|---|---|---|
| Comparative | none | 98 |
| Example 1 | | |

Evaluation 2

Read/write characteristics were evaluated using the perpendicular magnetic recording media of Examples 1, 2, 4 and 5 and Comparative Example 1. In evaluations of read/write characteristics, a magnetic head for thermally assisted magnetic recording, on which was mounted a laser with a spot diameter of 100 nm and a wavelength of 410 nm, was used. The laser driving current during recording was fixed at 50 mA.

Evaluations of read/write characteristics were performed by measuring overwrite (OW) values. OW values were measured using a method which included (1) a process of recording a first signal, at a linear recording density of 1000 kfci (kilo-flux changes per inch), on a track of the magnetic recording medium, and measuring the signal output (T1) of the first signal; (2) a process of overwriting a second signal on the same track at a linear recording density of 130 kfci, and measuring the signal output (T2) of the incompletely erased first signal after overwriting; and (3) using the following equation

OW(dB)=20×log(T1/T2)

to calculate the OW value (dB). Measurement results are shown in Table 2.

The OW values for the perpendicular magnetic recording media of Examples 2 and 5, with low reflectance of the reflectance change layer, were higher than the OW values for the perpendicular magnetic recording media of Examples 1 and 4 and Comparative Example 1, having reflectance change layers with high reflectance. This result indicates that in Examples 2 and 5, signals can easily be recorded on the perpendicular magnetic recording medium. In the perpendicular magnetic recording media of Examples 2 and 5 with low reflectance of the reflectance change layer, a larger amount of light penetrates the reflectance change layer to reach the magnetic recording layer, and so it is thought that the magnetic recording layer is heated efficiently. Further, in these evaluations the laser driving current was not changed. This means that, in order to obtain approximately the same OW value in a perpendicular magnetic recording medium with a low-reflectance reflectance change layer as the OW value of a perpendicular magnetic recording medium with a high-reflectance reflectance change layer, the laser driving current (laser output) necessary during recording can be reduced.

TABLE 2
Read/write characteristics of magnetic
recording media

| | Reflectance | Reflectance | OW value |
|---|---|---|---|
| | change layer | (%) | (dB) |
| Example 1 | GeSbTe | 63 | 25.2 |
| Example 2 | | 35 | 33.7 |
| Example 4 | Ti₃O₅ | 55 | 24.4 |
| Example 5 | | 8 | 34.5 |
| Comparative | none | 98 | 23.3 |
| Example 1 | | | |

Evaluation 3

In these evaluations, studies were conducted to determine whether perpendicular magnetic recording media of this invention are effective for narrowing the width of recording tracks without reducing the spot diameter of the laser light.

Signals were recorded at a linear recording density of 400 kfci onto the perpendicular magnetic recording media of Examples 1 to 7 and Comparative Example 1. At this time, the laser driving current during recording was fixed at 50 mA. For the perpendicular magnetic recording media of Examples 1, 2, 4 and 5 and Comparative Example 1, the laser spot diameter was set to 100 nm, and for the perpendicular magnetic recording media of Examples 3, 6 and 7, the laser spot diameter was set to 1 μm.

Next, the signal output was measured while moving the read head position in the radial direction relative to the recording track, and off-track profiles were measured. The off-track profile half-maximum width (the width between the two points at which the output value is half of the maximum signal output) was defined to be the effective track width. Results appear in Table 3.

TABLE 3
Effective track widths of perpendicular
magnetic recording media

| | | Reflectance (%) | | |
|---|---|---|---|---|
| | Reflectance | | Recording | Effective |
| | change | Recording | track | track width |
| | layer | track | periphery | (nm) |
| Example 1 | GeSbTe | 63 | | 298 |
| Example 2 | | 35 | | 303 |
| Example 3 | | 35 | 63 | 120 |
| Example 4 | Ti₃O₅ | 55 | | 295 |
| Example 5 | | 8 | | 299 |
| Example 6 | | 8 | 55 | 118 |
| Example 7 | | 8 | 55 | 236 |

| | | | |
|---|---|---|---|
| Comparative | none | 98 | 310 |
| Example 1 | | | |

From the results of Table 3, it is seen that in perpendicular magnetic recording media (Examples 1, 2, 4 and 5, and Comparative Example 1) in which there is no difference in the reflectances of recording tracks and the recording track periphery, the effective track widths (295 nm to 310 nm) are markedly larger than the spot diameter (100 nm) of the laser used when writing. On the other hand, in perpendicular magnetic recording media (Examples 3, 6 and 7) in which, prior to writing, positions corresponding to recording tracks are made low-reflectance regions and recording track peripheries are made high-reflectance regions, despite the fact that the spot diameter (1 μm=1000 nm) of the laser used when writing is markedly larger, the effective track widths are values close to the widths of the regions in which reflectance is lowered (100 nm or 200 nm). From this result, it is clear that by providing low-reflectance regions and high-reflectance regions in the reflectance change layer, control of the recording track width, and more specifically, regulation of the recording track width through the width of low-reflectance regions, is possible. This is attributed to (1) the fact that the magnetic recording layer positioned below a low-reflectance region is irradiated with laser light in a sufficient amount and so can be heated to the temperature necessary for thermally assisted recording, and (2) the fact that the amount of laser light irradiation of the magnetic recording layer in positions below a high-reflectance region is insufficient, and heating to the temperature necessary for thermally assisted recording does not occur.

### SUMMARY

In a magnetic recording medium of this invention, by providing a low-reflectance region of a reflectance change layer, it is possible to cause the magnetic recording layer therebelow to absorb laser light with high efficiency, and consequently the efficiency of heating of the magnetic recording layer can be enhanced. Further, using this phenomenon it is possible to improve the efficiency of heating of the magnetic recording layer only in specific regions, such as recording tracks and servo pattern recording regions.

Reducing the width of recording tracks contributes greatly to increase the recording density of the magnetic recording medium. Related to this, many efforts have been made to develop techniques for reducing the size of magnetic head elements and narrowing the region in which the magnetic field is applied, and techniques for reducing laser spot diameters to reduce the heated region of the magnetic recording layer. However, the former techniques result in reduced intensity of the applied magnetic field, while the latter techniques reduce the laser power that can be applied, and so lower the heated temperature of the magnetic recording layer.

The reflectance of Ti₃O₅ depends on the wavelength of the irradiating laser, but does not depend greatly on the power. Hence by for example using a laser with low power but with a small spot diameter to change the reflectance, and using a head with a large element size to impart a high-intensity magnetic field when writing signals to perform thermally assisted recording, signal recording track widths can be made narrow without reducing element sizes or the diameter of the heating laser spot.

It will be apparent to one skilled in the art that the manner of making and using the claimed invention has been adequately disclosed in the above-written description of the exemplary embodiments taken together with the drawings. Furthermore, the foregoing description of the embodiments according to the invention is provided for illustration only, and not for limiting the invention as defined by the appended claims and their equivalents.

It will be understood that the above description of the exemplary embodiments of the invention are susceptible to various modifications, changes and adaptations, and the same are intended to be comprehended within the meaning and range of equivalents of the appended claims.

### EXPLANATION OF REFERENCE NUMERALS

10 Nonmagnetic substrate
20 Nonmagnetic seed layer
30 Nonmagnetic underlayer
40 Magnetic recording layer
50 Reflectance change layer
52 Low-reflectance region
54 High-reflectance region
60 Liquid lubricating layer
80 Laser spot

What is claimed is:

1. A magnetic recording medium for thermally assisted recording, comprising at least a nonmagnetic substrate, a magnetic recording layer, and a reflectance change layer,
wherein the magnetic recording layer is positioned between the substrate and the reflectance change layer.

2. The magnetic recording medium for thermally assisted recording according to claim 1, wherein the reflectance change layer is formed from a material the reflectance of which can be changed reversibly.

3. The magnetic recording medium for thermally assisted recording according to claim 1, wherein the reflectance change layer is formed from a material the reflectance of which can be changed by irradiation with control light.

4. The magnetic recording medium for thermally assisted recording according to claim 3, wherein the reflectance change layer is formed from a phase transition material.

5. The magnetic recording medium for thermally assisted recording according to claim 3, wherein the reflectance change layer is formed from a material including one or a plurality of elements selected from a group consisting of germanium (Ge), antimony (Sb), tellurium (Te), gallium (Ga) and selenium (Se).

6. The magnetic recording medium for thermally assisted recording according to claim 3, wherein the reflectance change layer is formed from a metal-semiconductor phase transition material made of Ti₃O₅.

7. The magnetic recording medium for thermally assisted recording according to claim 1, wherein the reflectance change layer has a low-reflectance region and a high-reflectance region, and the reflectance of the low-reflectance region is equal to or lower than the reflectance of the high-reflectance region.

8. The magnetic recording medium for thermally assisted recording according to claim 7, wherein the magnetic recording medium for thermally assisted recording includes a recording track region and a servo region, and the low-reflectance region is formed in at least a portion of the recording track region.

9. The magnetic recording medium for thermally assisted recording according to claim 7, wherein the magnetic recording medium for thermally assisted recording includes a recording track region and a servo region, and the low-reflectance region is formed in at least a portion of the servo region.

10. An article of manufacture, comprising:
a data recording layer; and
a recording assistance layer formed on the data recording layer;
wherein a reflectance of the recording assistance layer is changeable by a controlled light irradiation on the recording assistance layer.

11. The article of manufacture of claim 10, wherein the recording assistance layer is configured to change a recording characteristic of the data recording layer based on the reflectance.

12. The article of manufacture of claim 10, wherein the recording assistance layer includes a material of a first reflectance that is changeable by the controlled light irradiation into a second reflectance different from the first reflectance.

13. The article of manufacture of claim 12, wherein a change by the controlled light irradiation is reversible.

14. The article of manufacture of claim 12, wherein an area having the first reflectance is formed over a position of the data recording layer where data is to be recorded.

15. The article of manufacture of claim 14, wherein the first reflectance is lower than the second reflectance.

16. The article of manufacture of claim 11, wherein a magnetic anisotropic energy of the data recording layer is changeable by a recording light irradiation associated with recording on the data recording layer, based on the reflectance, to change the recording characteristic of the data recording layer.

17. A method, comprising:
forming a data recording layer;
forming a recording assistance layer on the data recording layer; and
changing a reflectance of the recording assistance layer by a controlled light irradiation on the recording assistance layer.

18. The method of claim 17, further comprising:
changing the reflectance of the recording assistance layer to be lower in a region corresponding to a position of the data recording layer where data is to be recorded than in an adjacent region.

19. The method of claim 17, further comprising
reversing a change in the reflectance of the recording assistance layer.

20. The method of claim 17, further comprising:
irradiating the region of the recording assistance layer corresponding to the position of the data recording layer where data is to be recorded with a recording light to change a recording characteristic of the data recording layer.
